(19) United States
(12) Patent Application Publication
(10) Pub. No.: US 2008/0178503 A1
(43) Pub. Date: Jul. 31, 2008

(54) Matchcase display system and method

(76) Inventor: Todd Birge, Alpharetta, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/698,007

(22) Filed: Jan. 25, 2007

(51) Int. Cl. G09F 7/04; G09F 1/10

(52) U.S. Cl. 40/600; 40/124.04

(57) ABSTRACT

A system and method for displaying matchbooks and/or matchboxes without causing damage to the matchbooks and/or matchboxes, or to the matches therein, wherein the use of magnets and a piece of ferromagnetic material that allows for visually pleasing arrangement and rearrangement, and for removal and replacement of matchbooks and/or matchboxes.

### BACKGROUND OF THE INVENTION

1. Technical Field

The present invention relates generally to display systems, and more specifically, to a system and method for displaying matchbooks and matchboxes.

2. Description of Related Art

As with many other kinds of collections, a matchbook and/or matchbox collector may often wish to display various matchbooks and/or matchboxes from his or her collection for inspection by an appraiser or other enthusiasts or simply for his or her own enjoyment.

One way in which matchbooks and/or matchboxes have been displayed is pinned to a board, such as a corkboard. This method of displaying the matchbooks and/or matchboxes allow a collector to arrange the matchbooks and/or matchboxes in a visually appealing manner,i and allows the collector to rearrange, add, or remove individual matchbooks and/or matchboxes as he or she desires.

Unfortunately, however, this method of displaying matchbooks and/or matchboxes necessarily involves physical damage to the matchbooks and/or matchboxes displayed. This damage may reduce the value of the matchbooks and/or matchboxes, and may make them less appealing and/or collectable.

Another way in which matchbooks and/or matchboxes have been displayed is pressed flat and stored within a sheet of protective plastic. Typically each sheet holds a plurality of individual matchbooks and/or matchboxes, and a plurality of sheets may be stored in a binder, such as a three ring binder. This method of display allows inspection of the matchbooks and/or matchboxes with minimal physical damage thereto, but does not allow for convenient display of the matchbooks and/or matchboxes because only one protective sheet may be viewed at a time. Furthermore, arranging and rearranging the matchbooks and/or matchboxes is time consuming due to the necessary removal and insertion within the protective plastic sheet.

It is desirable, therefore, to provide a matchbook and/or matchbox display system and method that allows for open display of matchbooks and/or matchboxes wherein simple and convenient arrangement and rearrangement is facilitated within an aesthetically appealing display and wherein physical damage to the matchbooks and/or matchboxes is avoided displayed.

### BRIEF SUMMARY OF THE INVENTION

Briefly described, in a preferred embodiment, the present invention overcomes the above-mentioned disadvantages and meets the recognized need for such a device by providing a matchcase display comprising a matchcase, a magnet, and a piece of ferromagnetic material, wherein the matchcase is removably retained proximate the piece of ferromagnetic material by the magnet.

According to its major aspects and broadly stated, the present invention in its preferred form is a magnetic matchcase display.

According to another aspect of the preferred embodiment, the matchcases may be selectively arranged, rearranged, added, and/or removed.

According to another aspect of the preferred embodiment, the matchcases may be displayed vertically, such as on a wall.

According to another aspect of the preferred embodiment, the matchcases may be displayed without causing physical damage to the matchcase.

According to another aspect of the preferred embodiment, both matchbooks and matchboxes may be simultaneously displayed in a freeform arrangement.

According to another preferred embodiment of the invention, the present invention overcomes the above-mentioned disadvantages and meets the recognized need for such a device by providing a method of displaying a matchcase comprising the step of retaining a matchcase for display proximate a piece of ferromagnetic material using a magnet.

According to another aspect of the preferred embodiment, the matchcase is securely retained against the piece of ferromagnetic material due to the selective placement of the magnet within the matchcase.

According to another aspect of the preferred embodiment, the matchcase may be displayed without requiring removal of the matches.

According to another aspect of the preferred embodiment, the relative placement of the magnet and the ferromagnetic material can be switched.

According to another aspect of the preferred embodiment, a collectable set of matchcases may be provided with respective magnets placed therein and an associated ferromagnetic display of the matchcases is user selectable.

According to another aspect of the preferred embodiment, a matchcase may be offered in conjunction with a magnet insert and ferromagnetic display member for receiving the matchcase removably thereon.

These and other objects, features, and advantages of the invention will become more apparent to those ordinarily skilled in the art after reading the following Detailed Description and Claims in light of the accompanying drawing Figures.

### BRIEF DESCRIPTION OF THE DRAWINGS

Accordingly, the present invention will be understood best through consideration of, and reference to, the following Figures, viewed in conjunction with the Detailed Description of the Preferred Embodiment referring thereto, in which like reference numbers throughout the various Figures designate like structure and in which:

FIG. 1 is a perspective view of a preferred embodiment of the present invention;

FIG. 2 is a side cross-sectional view of a preferred embodiment of the present invention;

FIG. 3 is a perspective view of an alternative embodiment of the present invention; and

FIG. 4 is a side cross-sectional view of an alternative embodiment of the present invention.

It is to be noted that the drawings presented are intended solely for the purpose of illustration and that they are, therefore, neither desired nor intended to limit the invention to any or all of the exact details shown, except insofar as they may be deemed essential to the claimed invention.

### DETAILED DESCRIPTION OF THE INVENTION

In describing preferred embodiments of the present invention illustrated in the Figures, specific terminology is employed for the sake of clarity. The invention, however, is not intended to be limited to such specific terminology, and it will be understood that each specific element includes all technical equivalents that operate in a similar manner to accomplish a similar purpose.

It will be understood by one skilled in the art that matches are distributed in various types of packaging, including matchbooks and matchboxes. As used herein, the term matchcase is intended to include matchbooks, matchboxes, and other types of packaged matches, and/or packages for other articles which mimic designs used for distributing matches, such as, for exemplary purposes only, toothpicks, sewing kits, or other suitably packaged items. Thus, the term matchcase is not intended to limit the scope of the disclosure of the invention, or the claimed invention, to any specific structural arrangement.

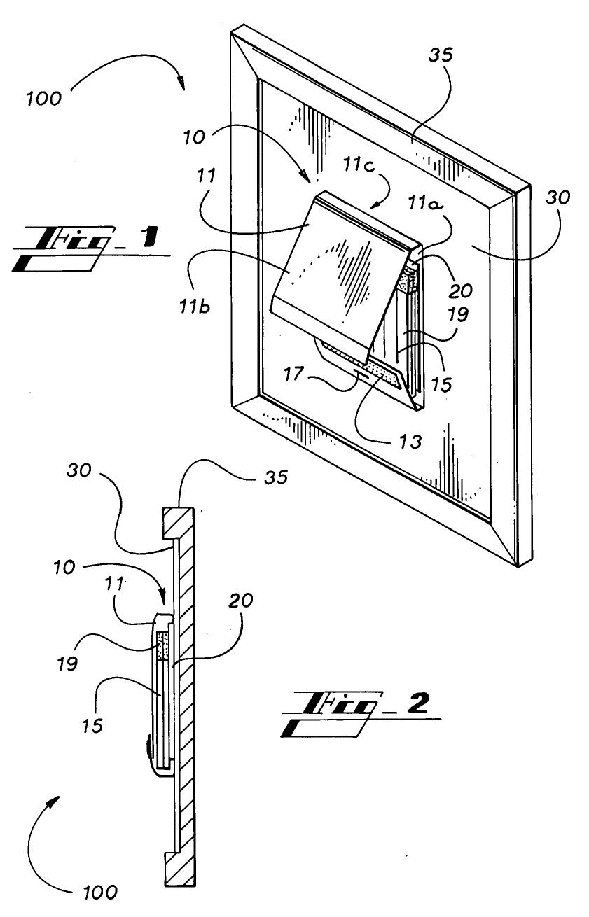

Now referring to the figures, in that form of the preferred embodiment of the present invention chosen for purposes of illustration, FIGS. 1 and 2 show display 100, including matchbook 10 preferably displayed on ferromagnetic plate 30 using magnet 20. Matchbook 20 preferably includes comb 15 of matches 19, which may optionally be attached to cover 11 by staple 17, or other suitable fastener or adhesive. Cover 11 may include striker 13 used for igniting matches 19.

Magnet 20 is preferably disposed proximate an interior surface 11a of cover 11, and is preferably sized such that magnet 20 does not extend beyond a perimeter of cover 11. Magnet 20 is preferably not glued or fastened to interior surface 11a or to any other part of matchbook 10. Thus, magnet 20 is preferably placed in between comb 15 and interior surface 11a and is preferably retained there by friction. If front 11b of matchbook 10 is to be displayed, then magnet 20 is preferably disposed between comb 15 and interior surface 11a of back 11c. Alternatively, if back 11c is to be displayed, then magnet 20 is preferably disposed between comb 15 and interior surface 11a of front 11b. Placing magnet 20 as described above preferably reduces a distance between magnet 20 and ferromagnetic plate 30 in order to increase an attractive force therebetween. When magnet 20 is so placed, matchbook 10 is preferably retained against ferromagnetic plate 30 with sufficient force to prevent unwanted movement of matchbook 10 over or relative to ferromagnetic plate 30, even when ferromagnetic plate 30 is vertically disposed, such as when mounted on a wall. Matchbook 10 may, however, preferably be manually removed and/or rearranged over ferromagnetic plate 30, thereby allowing a collector to create a visually pleasing display of matchcases.

Ferromagnetic plate 30 may optionally include frame 35 disposed therearound, such as a picture frame, to create a desired visual effect and presentation style. Furthermore, ferromagnetic plate 30 may optionally include a covering, such as a fabric, plastic, laminate or other similar surface treatment, or a paint, lacquer, or other surface coating. The coating or covering may optionally provide a desired visual effect, such as matte or glossy finish, color, etc., and may optionally provide functional characteristics, such as high-friction or water-resistance.

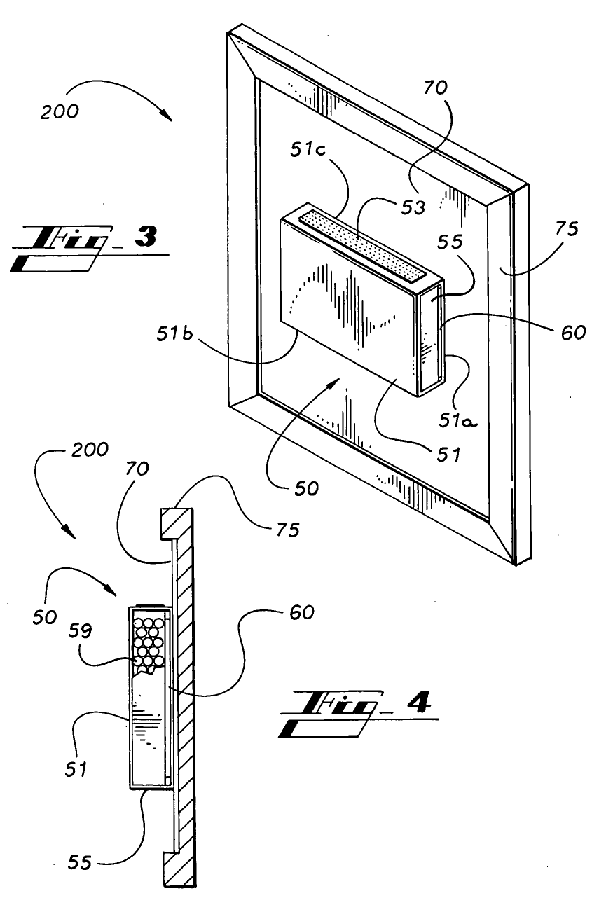

Now referring to FIGS. 3 and 4, in display 200, matchbox 50 is shown displayed on magnet 70 by ferromagnetic plate 60. Matchbox 50 preferably includes drawer 55 disposed within cover 51 containing a plurality of matches 59. Cover 51 preferably includes interior surface 51a, front 51b, and back 51c, and may optionally include striker 53. Ferromagnetic plate 60 is preferably disposed proximate interior surface 51a and proximate a top of drawer 55, the top being the open side. If matches 59 are disposed within drawer 55, then ferromagnetic plate 60 is preferably disposed on top of matches 59. Thus, when matchbox 50 is retained on magnet 70, ferromagnetic plate 60 is separated from magnet 70 only by cover 51, and not also by drawer 55. Thus, if front 51b is to be displayed, then ferromagnetic plate 60 is preferably disposed on top of matches 59 and adjacent to interior surface 51a of back 51c; with drawer 55 oriented with its bottom toward front 51b and its top oriented toward back 51c. Alternatively, if back 51c is to be displayed, then ferromagnetic plate 60 is preferably disposed on top of matches 59 and adjacent to interior surface 51a of front 51b; with drawer 55 oriented with its bottom toward back 51c and its top oriented toward back 51c. The arrangement of ferromagnetic plate 60 described above provides improved magnetic attraction between ferromagnetic plate 60 and magnet 70, and preferably retains matchbox 50 against magnet 70 with sufficient force to prevent unwanted movement between matchbox 50 and magnet 70, even when magnet 70 is oriented vertically, such as when displayed on a wall. Matchbox may preferably be removed and rearranged over magnet 70, thereby allowing a collector to create a visually appealing display. Further, ferromagnetic plate 60 may be removed from matchbox 50 in order to allow use of matches 59, and then may be replaced for continued display.

Having thus described the exemplary embodiments of the present invention, it should be noted by those skilled in the art that these disclosures are exemplary only and that various other alternatives, adaptations, and modifications may be made without departing from the scope and spirit of the present invention. Accordingly, the present invention is not limited to the specific embodiments as described and illustrated herein, but is only limited by the following claims.

What is claimed is at least:

1. A matchcase display comprising:
at least one matchcase;
a magnet removably carried within said at least one matchcase; and
a piece of ferromagnetic material,
wherein said at least one matchcase is removably retained proximate said piece of ferromagnetic material by a said magnet.

2. The matchcase display of claim 1, wherein said matchcase comprises a matchbook, and wherein said magnet is disposed proximate an interior surface of a cover of said matchbook proximate said piece of ferromagnetic material.

3. The matchcase display of claim 2, wherein said magnet is disposed generally between a comb of matches of said matchbook and said interior surface of said cover.

4. The matchcase display of claim 1, wherein said matchcase comprises a matchbox, and wherein said magnet is disposed proximate an interior surface of a cover of said matchbox proximate said piece of ferromagnetic material.

5. The matchcase display of claim 4, wherein said magnet is disposed proximate an opening of a drawer of said matchbox.

6. The matchcase display of claim 5, further comprising at least one match disposed within said drawer.

7. The matchcase display of claim 1, wherein said matchcase comprises a matchbook, and wherein said piece of ferromagnetic material is disposed proximate an interior surface of a cover of said matchbook proximate said magnet.

8. The matchcase display of claim 7, wherein said piece of ferromagnetic material is disposed generally between a comb of matches of said matchbook and said interior surface of said cover.

9. The matchcase display of claim 1, wherein said matchcase comprises a matchbox, and wherein said piece of ferromagnetic material is disposed proximate an interior surface of a cover of said matchbox proximate said magnet.

10. The matchcase display of claim 9, wherein said piece of ferromagnetic material is disposed proximate an opening of a drawer of said matchbox.

11. The matchcase display of claim 10, further comprising at least one match disposed within said drawer.

12. The matchcase display of claim 1, further comprising a plurality of magnets, wherein said at least one matchcase comprises a plurality of matchcases, each one of said plurality of magnets being operatively and removably associated with a respective one of said plurality of matchcases.

13. The matchcase display of claim 1, further comprising a plurality of pieces of ferromagnetic material wherein said at least one matchcase comprises a plurality of matchcases, each of said plurality of pieces of ferromagnetic material being operatively and removably associated with a respective one of said plurality of matchcases.

14. A method of displaying a matchcase comprising the step of:
retaining a matchcase for display proximate a piece of ferromagnetic material using a magnet removably contained within said matchcase.

15. The method of displaying a matchcase of claim 14, wherein said step of retaining comprises disposing said magnet proximate an interior surface of a cover of said matchcase.

16. The method of displaying a matchcase of claim 15, wherein said matchcase comprises a matchbook, and wherein said step of disposing comprises disposing said magnet generally between a comb of matches of said matchbook and said interior surface.

17. The method of displaying a matchcase of claim 15, wherein said matchcase comprises a matchbox, and wherein said step of disposing comprises disposing said magnet proximate an opening of a drawer of said matchbox.

18. The method of displaying a matchcase of claim 14, further comprising the step of retaining a second matchcase for display proximate said piece of ferromagnetic material using a second magnet.

19. The method of displaying a matchcase of claim 14, further comprising the additional steps of removing said matchcase from said piece of ferromagnetic material, and replacing said matchcase proximate said ferromagnetic material.

20. A method of displaying a matchcase comprising the step of:
retaining a matchcase for display proximate a magnet using a piece of ferromagnetic material removably carried within said matchcase.
